(19) United States
(12) Patent Application Publication
(10) Pub. No.: US 2026/0178902 A1
(43) Pub. Date: Jun. 25, 2026

(54) TRAINING METHOD OF DEEP LEARNING MODEL FOR SIMILAR WAFER MAP ESTIMATION AND COMPUTING DEVICE PERFORMING THE TRAINING METHOD

(71) Applicant: Samsung Electronics Co., Ltd., Suwon-si (KR)

(72) Inventors: Hyeyeon Choi, Suwon-si (KR); Kyounghoon Kang, Suwon-si (KR); Youngjae Kim, Suwon-si (KR)

(21) Appl. No.: 19/414,490

(22) Filed: Dec. 10, 2025

(30) Foreign Application Priority Data
Dec. 23, 2024 (KR) 10-2024-0194341

(51) Int. Cl. G06N 3/08; G06T 5/60; G06T 5/70; G06T 7/00

(52) U.S. Cl. CPC G06N 3/08; G06T 5/60; G06T 5/70; G06T 7/001; G06T 2207/20081; G06T 2207/30148

(57) ABSTRACT

A method of training a deep learning model includes blurring a plurality of wafer maps including a first target wafer map to provide a plurality of blurred wafer maps including a blurred first target wafer map, constructing first training data from the plurality of blurred wafer maps, based on a pixel-based similarity index, and pre-training the deep learning model based on the first training data, which include first positive and first negative sets of wafer maps. The first positive set of wafer maps includes wafer maps of the plurality of blurred wafer maps, which are high in similarity with the blurred first target wafer map according to the pixel-based similarity index, and the first negative set of wafer maps includes wafer maps of the plurality of blurred wafer maps, which are low in similarity with the blurred first target wafer map according to the pixel-based similarity index.

### CROSS-REFERENCE TO RELATED APPLICATIONS

This application claims priority under 35 U.S.C. § 119 to Korean Patent Application No. 10-2024-0194341, filed on Dec. 23, 2024, in the Korean Intellectual Property Office, the disclosure of which is incorporated by reference herein in its entirety.

### BACKGROUND

The present disclosure relates to a method of training a deep learning model for similar wafer map estimation and a computing device performing the method.

In the semiconductor industry, a technology for quickly analyzing a defect pattern of a manufactured wafer to find a defect cause and for tracking a process requiring improvement is very important to develop products and to manage mass-produced products. However, because the wafer is manufactured through numerous process steps, various types of defect patterns may occur due to countless factors. In particular, because there occur new types of defect patterns, which are not previously discovered, it is difficult to classify and manage defect patterns into pre-standardized types.

Also, whether defect patterns present in wafers are similar may be determined by a professional engineer with the domain knowledge in the field. For this reason, there is a limitation in finding similar wafer maps in which defect patterns are similar, by utilizing a geometric filter which simply extracts morphological features (e.g., an area, a circumference, and a distance to the center).

### SUMMARY

Embodiments of the present disclosure provide a method of training a deep learning model capable of estimating similar wafer maps with higher performance and a computing device performing the method.

According to an embodiment, a method of training a deep learning model for wafer map similarity estimation may be provided. The method may be performed by a computing device including at least one processor and may include blurring a plurality of wafer maps including a first target wafer map to provide a plurality of blurred wafer maps including a blurred first target wafer map, constructing first training data from the plurality of blurred wafer maps, based on a pixel-based similarity index, and pre-training the deep learning model based on the first training data. The first training data may include a first positive set of wafer maps and a first negative set of wafer maps. The first positive set of wafer maps may include wafer maps, which are high in similarity with the blurred first target wafer map according to the pixel-based similarity index, from among the plurality of blurred wafer maps, and the first negative set of wafer maps may include wafer maps, which are low in similarity with the blurred first target wafer map according to the pixel-based similarity index, from among the plurality of blurred wafer maps.

In addition, the constructing of the first training data may include randomly selecting candidate wafer maps from the plurality of blurred wafer maps, calculating a similarity with the blurred first target wafer map by using the pixel-based similarity index, for each of the candidate wafer maps, and selecting a first number of similar wafer maps and a second number of non-similar wafer maps from the candidate wafer maps based on the calculated similarity for each of the candidate wafer maps. The first positive set of wafer maps may include the first number of similar wafer maps, and the first negative set of wafer maps may include the second number of non-similar wafer maps.

Also, the constructing of the first training data may further include generating at least one first augmentation wafer map from the blurred first target wafer map by using a data augmentation technique, generating at least one second augmentation wafer map from each of the first number of similar wafer maps by using the data augmentation technique, and generating at least one third augmentation wafer map from each of the second number of non-similar wafer maps by using the data augmentation technique. The first positive set of wafer maps may include the at least one first augmentation wafer map and the at least one second augmentation wafer map, and the first negative set of wafer maps may include the at least one third augmentation wafer map.

Furthermore, the selecting of the first number of similar wafer maps and the second number of non-similar wafer maps may include selecting wafer maps, each of which has the calculated similarity greater than a first threshold value, from among the candidate wafer maps, and selecting the first number of similar wafer maps from the wafer maps, each of which has the calculated similarity greater than the first threshold value, in order of the calculated similarity.

Besides, the selecting of the first number of similar wafer maps and the second number of non-similar wafer maps may include selecting wafer maps, each of which has the calculated similarity smaller than a second threshold value, from among the candidate wafer maps, and randomly selecting the second number of non-similar wafer maps from the wafer maps, each of which has the calculated similarity smaller than the second threshold value.

Moreover, the pixel-based similarity index may be calculated based on the following Equation:

$$BIoM ( X {\hat{}}^{′} , Y {\hat{}}^{′} ) = ( \sum \_i min ( x\_i {\hat{}}^{′} , y\_i {\hat{}}^{′} ) ) / ( max ( \sum \_i x\_i {\hat{}}^{′} , \sum \_i {y\_i}^{′} ) )$$

$${X}^{′} = f ( X ) , {Y}^{′} = f ( Y ) , {x}_{i}^{′} ∈ {X}^{′} , {y}_{i}^{′} ∈ {Y}^{′} ,$$

in which BIoM may represent the pixel-based similarity index, “X” and “Y” may represent different wafer maps, f(⋅) may represent a blur filter, and each of

$${x}_{i}^{′} and {y}_{i}^{′}$$

may represent an individual pixel of each wafer map.

In addition, the deep learning model may be a model extracting features based on a convolutional operation, and the pre-training may include inputting the blurred first target wafer map and the first training data to the deep learning model to extract features, and applying a loss function to the extracted features to update parameters of the deep learning model.

Also, the method may further include constructing labeling data including wafer maps, each of which is labeled as a wafer map similar to a second target wafer map, from among the plurality of wafer maps, constructing second training data including the labeling data, and post-training the pre-trained deep learning model based on the second training data, and the second target wafer map may be a wafer map, which is selected by a user having domain knowledge, from among the plurality of wafer maps.

Furthermore, the constructing of the labeling data may include selecting a third number of wafer maps from the plurality of wafer maps in order where a similarity with the second target wafer map estimated by using the pre-trained deep learning model is high, selecting a fourth number of wafer maps from the plurality of wafer maps in order where a similarity with the second target wafer map calculated according to the pixel-based similarity index is high, constructing a labeling data candidate group by removing duplicate wafer maps from the third number of wafer maps and the fourth number of wafer maps, and labeling a fifth number of wafer maps selected from wafer maps included in the labeling data candidate group as a wafer map similar to the second target wafer map.

Besides, the selecting of the third number of wafer maps may include blurring the plurality of wafer maps to provide a second plurality of blurred wafer maps, inputting the second plurality of blurred wafer maps to the pre-trained deep learning model to extract features of each wafer map, estimating a similarity with the second target wafer map based on the extracted features, for each of the second plurality of blurred wafer maps, and selecting the third number of wafer maps based on the estimated similarity for each of the second plurality of blurred wafer maps.

Moreover, the constructing of the second training data may include blurring the plurality of wafer maps to provide a second plurality of blurred wafer maps, and constructing the second training data from the second plurality of blurred wafer maps, and the second training data may include a second positive set of wafer maps including the labeled wafer maps among the second plurality of blurred wafer maps, and a second negative set of wafer maps including wafer maps, which are low in a similarity with the second target wafer map according to the pixel-based similarity index, from among the second plurality of blurred wafer maps, or including wafer maps, which are low in a similarity with the second target wafer map estimated by using the pre-trained deep in learning model, from among the second plurality of blurred wafer maps.

In addition, the method may further include generating at least one fourth augmentation wafer map from each of the blurred second target wafer map and the blurred labeled wafer maps by using a data augmentation technique, and the second positive set of wafer maps may include the at least one fourth augmentation wafer map.

Also, the post-training may include applying parameters of the pre-trained deep learning model to the deep learning model, inputting the blurred second target wafer map and the second training data to the deep learning model to extract features, and applying a loss function to the extracted features to update parameters of the deep learning model.

According to an embodiment, a computing device may include a processor including at least one core, and a memory including program codes and a deep learning model, which are executable in the processor. The processor may execute at least some of the program codes to blur a plurality of wafer maps including a first target wafer map to provide a plurality of blurred wafer maps including a blurred first target wafer map, may construct first training data from the plurality of blurred wafer maps, based on pixel-based similarity index; and may pre-train the deep learning model based on the first training data. The training data may include a first positive set of wafer maps and a first negative set of wafer maps, the first positive set of wafer maps may include wafer maps, which are high in a similarity with the first target wafer map according to the pixel-based similarity index, from among the plurality of blurred wafer maps, and the first negative set of wafer maps may include wafer maps, which are low in the similarity, from among the plurality of blurred wafer maps.

In addition, the processor may randomly select candidate wafer maps from the plurality of blurred wafer maps, and may calculate a similarity with the blurred first target wafer map by using the pixel-based similarity index, for each of the candidate wafer maps, and may select a first number of similar wafer maps and a second number of non-similar wafer maps from the candidate wafer maps based on the calculated similarity for each of the candidate wafer maps. The first positive set of wafer maps may include the first number of similar wafer maps, and the first negative set of wafer maps may include the second number of non-similar wafer maps.

Also, the processor may generate at least one first augmentation wafer map from the blurred first target wafer map by using a data augmentation technique, may generate at least one second augmentation wafer map from each of the first number of similar wafer maps, and may generate at least one third augmentation wafer map from each of the second number of non-similar wafer maps. The first positive set of wafer maps may include the at least one first augmentation wafer map and the at least one second augmentation wafer map, and the first negative set of wafer maps may include the at least one third augmentation wafer map.

Furthermore, the processor may calculate a similarity according to the pixel-based similarity index based on the following Equation:

$$BIoM ( {X}^{′} , {Y}^{′} ) = \frac{{\sum }_{i} min ( {x}_{i}^{′} , {y}_{i}^{′} )}{max ( {\sum }_{i} {x}_{i}^{′} , {\sum }_{i} {y}_{i}^{′} )}$$

$${BX}^{′} = f ( X ) , {Y}^{′} = f ( Y ) , {x}_{i}^{′} ∈ {X}^{′} , {y}_{i}^{′} ∈ {Y}^{′} ,$$

in which BIoM may represent the pixel-based similarity index, “X” and “Y” may represent different wafer maps, f(⋅) may represent a blur filter, and each of

$${x}_{i}^{′} and {y}_{i}^{′}$$

may represent an individual pixel of each wafer map.

Besides, the processor may construct labeling data including wafer maps, which are labeled as a wafer map similar to a second target wafer map, from among the plurality of wafer maps, may construct second training data including the labeling data, and may post-train the pre-trained deep learning model based on the second training data, and the second target wafer map may be a wafer map, which is selected by a user having domain knowledge, from among the plurality of wafer maps.

Moreover, the processor may select a third number of wafer maps from the plurality of wafer maps in order where a similarity with the second target wafer map estimated by using the pre-trained deep learning model is high, may select a fourth number of wafer maps from the plurality of wafer maps in order where a similarity with the second target wafer map calculated according to the pixel-based similarity index is high, may construct a labeling data candidate group by removing duplicate wafer maps from the third number of wafer maps and the fourth number of wafer maps, and may label a fifth number of wafer maps selected from wafer maps included in the labeling data candidate group as a wafer map similar to the second target wafer map.

According to an embodiment, a non-transitory computer-readable recording medium storing a program is provided. The program, when executed by a processor of a computing device, may cause the computing device to perform an operation. The operation may include blurring a plurality of wafer maps including a first target wafer map to provide a plurality of blurred wafer maps including a blurred first target wafer map, constructing first training data from the plurality of blurred wafer maps, based on pixel-based similarity index, pre-training a deep learning model based on the first training data, constructing labeling data including wafer maps, which are labeled as a wafer map similar to a second target wafer map, from among the plurality of wafer maps, constructing second training data including the labeling data, and post-training the pre-trained deep learning model based on the second training data. The first training data may include a first positive set of wafer maps and a first negative set of wafer maps. The first positive set of wafer maps may include wafer maps, which are high in a similarity with the first target wafer map according to the pixel-based similarity index, from among the plurality of blurred wafer maps, the first negative set of wafer maps may include wafer maps, which are low in the similarity, from among the plurality of blurred wafer maps, and the second target wafer map may be a wafer map, which is selected by a user having domain knowledge, from among the plurality of wafer maps.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a configuration of a computing device according to an example embodiment of the present disclosure.

FIG. 2A is a diagram for describing an example of a wafer map according to an example embodiment of the present disclosure.

FIG. 2B is a diagram for describing an example of similar wafer maps and non-similar wafer maps according to an example embodiment of the present disclosure.

FIG. 3 is a block diagram illustrating a configuration of a computing device according to an example embodiment of the present disclosure.

FIG. 4 is a diagram for describing an example of a blurring operation according to an example embodiment of the present disclosure.

FIG. 5A is a diagram for describing training data according to an example embodiment of the present disclosure.

FIG. 5B is a diagram for describing training data according to an example embodiment of the present disclosure.

FIG. 6 is a diagram for describing how to construct training data according to an example embodiment of the present disclosure.

FIG. 7 is a diagram illustrating an example of a process of training a deep learning model according to an example embodiment of the present disclosure.

FIG. 8 is a diagram illustrating an example of an estimation process of a deep learning model according to an example embodiment of the present disclosure.

FIG. 9 is a flowchart illustrating a deep learning model training process of a computing device according to an example embodiment of the present disclosure.

FIG. 10 is a flowchart illustrating a training data construction process of a computing device according to an example embodiment of the present disclosure.

FIG. 11 is a flowchart illustrating a training data construction process of a computing device according to an example embodiment of the present disclosure.

FIG. 12 is a flowchart illustrating a deep learning model training process of a computing device according to an example embodiment of the present disclosure.

FIG. 13 is a flowchart illustrating a labeling data construction process of a computing device according to an example embodiment of the present disclosure.

FIG. 14 is a flowchart illustrating a similarity estimation process of a computing device according to an example embodiment of the present disclosure.

FIG. 15 is a flowchart illustrating a training data construction process of a computing device according to an example embodiment of the present disclosure.

### DETAILED DESCRIPTION

Below, embodiments of the present disclosure will be described in detail.

In the present disclosure, the expressions “first”, “second”, etc. may modify various components regardless of the order and/or the importance, are only used to distinguish one component from another component, and are not intended to limit the corresponding components. Like reference characters refer to like elements throughout.

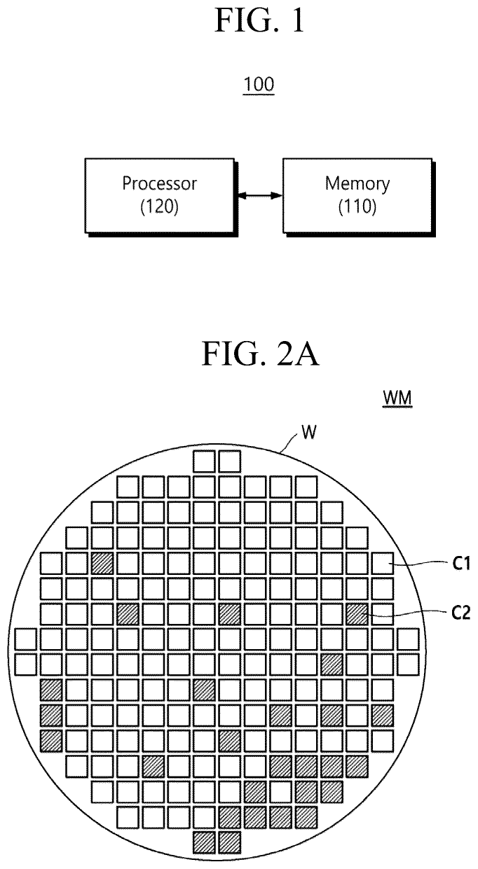

FIG. 1 is a block diagram illustrating a configuration of a computing device according to an example embodiment of the present disclosure. Referring to FIG. 1, a computing device 100 may include a memory 110 and a processor 120.

The memory 110 may store program codes and various kinds of data for the operation of the computing device 100. To this end, the memory 110 may include at least one of a random access memory (RAM), a read-only memory (ROM), a flash memory, a hard disk, a solid state drive (SSD), a card-type memory (e.g., an SD or XD memory), a magnetic memory, a magnetic disk, and an optical disk. Meanwhile, the computing device 100 may operate in connection with web storage which performs a storage function of the memory 110 on the Internet. For example, the computing device 100 may operate in conjunction with web-based storage, which may serve as an Internet-based extension of the memory 110.

The memory 110 may store a wafer map database including a plurality of wafer maps. In this case, each of the plurality of wafer maps may refer to image data indicating whether each of chips in the corresponding wafer or each of shots is good (e.g., functional) or bad (e.g., defective). For example, each of the plurality of wafer maps may comprise image data identifying a condition of at least one of each chip or each shot, the condition including whether the chip or the shot is good or bad. In example embodiments, each of the plurality of wafer maps may be obtained through an electrical die sorting (EDS) process among semiconductor wafer manufacturing processes, and may be then stored in the memory 110. However, the present disclosure is not limited thereto.

Also, the memory 110 may store a deep learning model. In this case, the deep learning model may be a convolutional neural network (CNN) which extracts features based on a convolutional operation.

The processor 120 may control all operations of the computing device 100. The processor 120 may include one or more cores. The processor 120 may include at least one of a central processing unit (CPU), a graphic processing unit (GPU), an application processor (AP), a communication processor (CP), or a tensor processing unit (TPU). The processor 120 may execute the program codes stored in the memory 110 to perform the operation of the computing device 100 according to various embodiments of the present disclosure.

The processor 120 may execute at least some of the program codes to train the deep learning model stored in the memory 110. For example, the processor 120 may train the deep learning model such that a wafer map, which is similar to a target wafer map, from among the plurality of wafer maps is estimated. For example, the processor 120 may be configured to train the deep learning model to estimate, from among the plurality of wafer maps, a wafer map that is similar to a target wafer map.

To this end, according to an embodiment, the processor 120 may construct training data from a plurality of first wafer maps and may pre-train the deep learning model based on the constructed training data. Below, the training data for pre-training the deep learning model are referred to as “first training data”. In this case, the plurality of first wafer maps may be at least some wafer maps, which are selected by the user to construct the first training data, from among all the wafer maps stored in the memory 110.

In detail, the processor 120 may blur the plurality of first wafer maps including a first target wafer map. For example, the processor 120 may blur the plurality of first wafer maps by applying a blur filter to each of the plurality of first wafer maps. In this case, the first target wafer map may be one wafer map, which is selected as a criterion used for the user to determine the similarity, from among the plurality of first wafer maps.

Also, the processor 120 may construct the first training data from the plurality of first wafer maps that are blurred by the processor 120, based on pixel-based similarity index. In an embodiment, the first training data may include a first positive set of wafer maps and a first negative set of wafer maps. The first positive set of wafer maps may include wafer maps, which are relatively high in similarity with the first target wafer map according to the similarity index, from among the plurality of first wafer maps that are blurred, and the first negative set of wafer maps may include wafer maps, which are relatively low in similarity with the first target wafer map, from among the plurality of first wafer maps that are blurred. In this case, the pixel-based similarity index may be an index for estimating the similarity between pixels of two blurred wafer maps. Accordingly, the processor 120 may calculate the similarity with the first target wafer map by using the pixel-based similarity index, for each of the plurality of first wafer maps. Based on the calculated similarities, the processor 120 may individually construct a first positive set of wafer maps including a preset number of wafer maps with a relatively high similarity and a first negative set of wafer maps including a preset number of wafer maps with a relatively low similarity. According to the above description, the processor 120 may pre-train the deep learning model based on the first training data.

When a target wafer map and comparison-targeted wafer maps are input, the deep learning model pre-trained as described above may extract features for estimating the similarity with the input target wafer map for each of the comparison-targeted wafer maps. Accordingly, according to an embodiment of the present disclosure, even when data labeled as a similar wafer map by the engineer do not exist, the deep learning model for similar wafer map estimation may be trained.

Meanwhile, according to an embodiment, the processor 120 may construct training data from a plurality of second wafer maps and may post-train the pre-trained deep learning model based on the constructed training data. Below, the training data for post-training the pre-trained deep learning model are referred to as “second training data”. In this case, the second training data may include labeling data. The labeling data may include wafer maps, each of which is labeled as a wafer map similar to a second target wafer map, from among the plurality of second wafer maps. The second target wafer map may be one wafer map selected as representing the plurality of second wafer maps by the user (or engineer) having the domain knowledge associated with similar map determination. Meanwhile, the plurality of second wafer maps may be at least some wafer maps, which are selected by the user to construct the second training data, from among all the wafer maps stored in the memory 110. In this case, the plurality of second wafer maps may be the same as the plurality of first wafer maps, or at least some of the plurality of second wafer maps and the plurality of first wafer maps may be different.

According to the above description, the pre-trained deep learning model may be finely tuned through the post-training. Because the second training data used for post-training include the labeling data provided by the engineer having the domain knowledge associated with similar map determination, the similar wafer map estimation may be made more accurately through the deep learning model post-trained based on the second training data.

According to various embodiments of the present disclosure described above, even in the case where the labeling data do not exist, the deep learning model may be trained to estimate similar wafer maps more accurately. Also, in the case where the labeling data exist, the performance of the deep learning model associated with the similar wafer map estimation may be further improved.

Meanwhile, FIG. 1 shows an example of the configuration of the computing device 100, and the present disclosure is not limited thereto. Depending on implementation examples, the computing device 100 may further include any other components for performing the operation of the computing device 100. For example, the computing device 100 may be implemented with various computing devices such as a PC, a notebook, a workstation, a display device, a measurement device, a robot device, and a server device, but the present disclosure is not limited thereto.

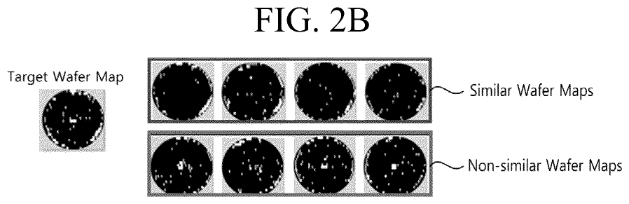

FIG. 2A is a diagram for describing an example of a wafer map according to an example embodiment of the present disclosure. Referring to FIG. 2A, a wafer W may be a silicon substrate which is used in the process of manufacturing a semiconductor device, and the semiconductor device (e.g., a transistor) may be formed on a surface of the wafer W. The fab-out wafer W may be divided into a plurality of units C1 and C2 in a next dicing process. Each of the plurality of units C1 and C2 may be implemented in units of chip, but the present disclosure is not limited thereto. For example, the plurality of units C1 and C2 may be variously implemented in units of block, shot, etc.

Raw data may be extracted in units of wafer W. Also, raw data may be extracted from each of the plurality of units C1 and C2 of the wafer W. The plurality of units C1 and C2 may be variously tested to detect a defect of the wafer W. The raw data may be data which include a result of performing the test. The test may include an electrical test for verifying a short-circuit, a leakage current, an operation time, etc. of the transistor formed in the wafer W. Accordingly, the raw data may represent one or more electrical characteristics of each of the plurality of units C1 and C2.

A wafer map WM may be an image expressing an electrical characteristic for each of the plurality of units C1 and C2 on a plan view of the wafer W based on the raw data. That is, the wafer map WM may be a raw data-mapped image.

Each of the plurality of units C1 and C2 may be classified into a good unit C1 or a bad unit C2. The good unit C1 may mean a unit with a good characteristic, and the bad unit C2 may mean a unit with a bad characteristic. For example, the good unit C1 may include a unit whose electrical characteristic is greater than or equal to a threshold value, and the bad unit C2 may include a unit whose electrical characteristic is smaller than the threshold value.

According to an embodiment, the good unit C1 and the bad unit C2 may be expressed in the wafer map WM by different brightnesses, saturations, or colors. In another embodiment, the wafer map WM may be expressed by any other manner except for a brightness, a saturation, or a color. A defect pattern may be expressed in the wafer map WM by using different brightnesses, saturations, or colors of two steps like the good unit C1 and the bad unit C2, but the present disclosure is not limited thereto. For example, the plurality of units C1 and C2 may be classified by using three or more steps. For example, the plurality of units C1 and C2 may be expressed by different brightnesses, saturations, or colors of five steps. The wafer map WM may be expressed by continuous values, not discrete values. In this case, the wafer map WM may be continuously expressed for each of the plurality of units C1 and C2 by using a brightness, a saturation, a color, or any other manner.

FIG. 2B is a diagram for describing an example of similar wafer maps and non-similar wafer maps according to an example embodiment of the present disclosure. FIG. 2B illustrates a target wafer map, similar wafer maps determined by the engineer having the domain knowledge associated with similar wafer map determination as being similar to the target wafer map and non-similar wafer maps determined by the engineer as being non-similar to the target wafer map.

Referring to FIG. 2B, it may be understood that whether wafer maps are similar is not determined by an amateur based on simple morphological features, but it is determined by the expert who has accumulated the domain knowledge in the field.

Because conventional technologies extract and utilize predefined morphological features (e.g., a width, a circumference, and a distance to the center) only to determine whether wafer maps are similar, the conventional technologies have a limitation in applying the domain knowledge associated with a defect pattern of a wafer map. Also, because it is practically impossible to standardize the definition of similar wafer maps based on the domain knowledge, there is a limitation on performance of searching for similar wafer maps through a rule-based manner or a machine vision operating based on a certain criterion.

However, according to embodiments of the present disclosure, a deep learning manner being a data-based algorithm is introduced to search for similar wafer maps. Also, even in the case where the labeling data do not exist, the deep learning model may be pre-trained to extract features appropriate for similar wafer map estimation. Also, the domain knowledge may be applied to the deep learning model by post-training the deep learning model by using the labeling data. According to the above description, a deep learning model capable of estimating similar wafer maps with higher performance may be provided.

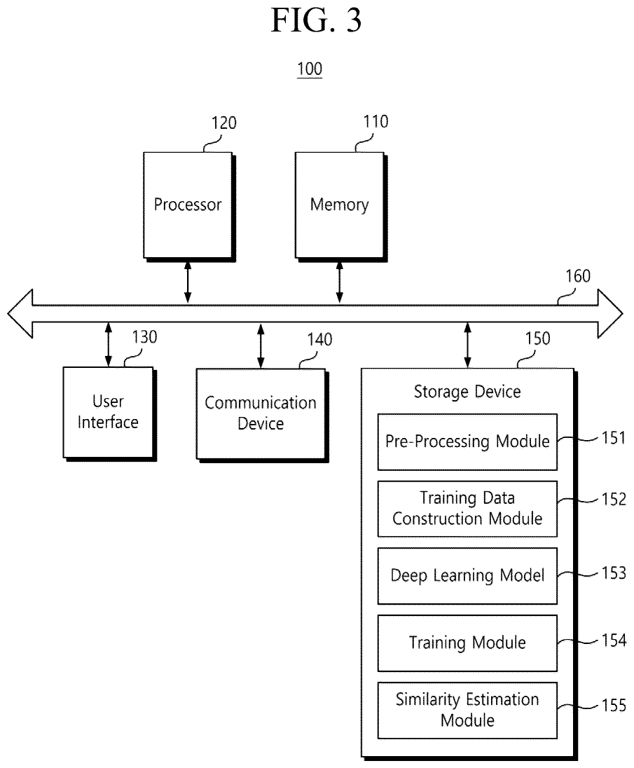

FIG. 3 is a block diagram illustrating a configuration of a computing device according to an example embodiment of the present disclosure. The computing device 100 of FIG. 3 may be an example of the computing device 100 of FIG. 1. Referring to FIG. 3, the computing device 100 may include the memory 110, the processor 120, a user interface 130, a communication device 140, a storage device 150, and a communication bus 160 that allows communication between the memory 110, the processor 120, the user interface 130, the communication device 140, and the storage device 150.

The memory 110 may store program codes and various kinds of data for the operation of the computing device 100. The memory 110 may be used as a main memory device of the computing device 100 and may include a volatile memory such as an SRAM and/or a DRAM. According to an embodiment, the memory 110 may further include a nonvolatile memory such as a PRAM and/or an RRAM. According to an embodiment, various kinds of modules (e.g., modules 151 to 155) stored in the storage device 150 may be loaded to the memory 110 and may be executed by the processor 120. Also, the plurality of wafer maps stored in the storage device 150 or the plurality of wafer maps received through the communication device 140 may be loaded to the memory 110 and may be used by the processor 120 for operations of the various modules 151 to 155.

The processor 120 may control all operations of the computing device 100. In particular, the processor 120 may perform the function of each module by loading and executing the modules 151 to 155 stored in the storage device 150 to the memory 110. The modules 151 to 155 may each correspond to a separate segment or segments of software (e.g., a subroutine) which configure the computing device 100. As is understood, “software” refers to prescribed rules to operate a computer, such as code or script.

The user interface 130 may provide the interaction with the user. For example, the user may control the operation of the computing device 100 through the user interface 130. According to an embodiment, through a graphic user interface (GUI) displayed in the computing device 100, the user may select some (e.g., the plurality of first wafer maps or the plurality of second wafer maps described above) of all the wafer maps included in the wafer map database, may select a target wafer map (e.g., the first target wafer map or the second target wafer map described above), or may select a predetermined number of wafer maps for labeling. To this end, the user interface 130 may include various kinds of user input/output devices such as a display, a speaker, a mouse, and a keyboard.

The communication device 140 may perform communication with an external device. For example, the communication device 140 may communicate with an external device (e.g., a server, a measurement device, a portable storage device, or a portable terminal device) which stores the wafer map database. The wafer map database obtained through the communication device 140 may be stored in the storage device 150.

To this end, the communication device 140 may include at least one communication module among a short-range wireless communication module (not illustrated) and a wireless LAN communication module (not illustrated). Herein, the short-range wireless communication module (not illustrated) may be a Bluetooth module, a ZigBee module, an NFC module, etc. Also, the wireless LAN communication module (not illustrated) is a module which connects to an external network in compliance with a wireless communication protocol such as a Wi-Fi or IEEE and performs communication. In addition, the communication device 140 may further include a mobile communication module which connects to a mobile communication network in compliance with various mobile protocols such as 3G, 3GPP, long term evolution (LTE), and 5G and performs communication. Also, the communication device 140 may include at least one of wired communication modules (not illustrated) such as a high-definition multimedia interface (HDMI), a universal serial bus (USB), institute of electrical and electronics engineers (IEEE) 1394, and RS-232.

The storage device 150 may store various kinds of program modules and data for performing functions of the computing device 100. To this end, the storage device 150 may include at least one of a flash memory, a hard disk, a solid state drive (SSD), a card-type memory (e.g., an SD or XD memory), a magnetic memory, a magnetic disk, and an optical disk. Also, the storage device 150 may include a volatile memory such as an SRAM and/or a DRAM.

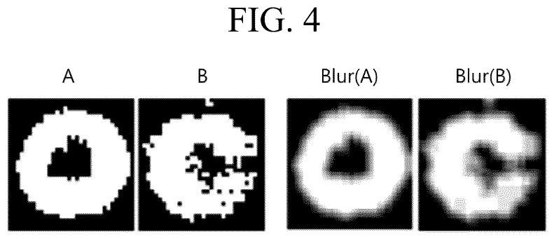

Below, operations of the computing device 100, which are performed by the modules 151, 152, 154, and 155 and the deep learning model 153 included in the storage device 150, will be described with reference to FIGS. 4 to 8 together with FIG. 3.

Referring to FIG. 3, the storage device 150 may include the preprocessing module 151. The preprocessing module 151 may adjust the size of a wafer map input thereto. A plurality of wafer maps input to the preprocessing module 151 may have various sizes. The preprocessing module 151 may adjust sizes of the wafer maps input to the preprocessing module 151 to a predetermined size such that wafer maps always having the same size are input to the deep learning model 153.

Also, the preprocessing module 151 may blur the input wafer maps. For example, the preprocessing module 151 may blur the wafer maps by applying the blur filter to each of the wafer maps. In this case, a Gaussian filter or an average filter may be used as the blur filter, but the present disclosure is not limited thereto. FIG. 4 illustrates an example of wafer maps “A” and “B” input to the preprocessing module 151 and wafer maps Blur (A) and Blur (B) blurred through the preprocessing module 151.

One wafer map may be expressed by using a binary map mostly consisting of 0s (zeroes) and 1s (ones). According to an embodiment, the target wafer map may be a single wafer map. In this case, the target wafer map may be a binary image. Alternatively, according to an embodiment, the target wafer map be a composite map. Herein, the composite map may be obtained by averaging multiple wafer maps. In this case, the target wafer map may be a gray image. As described above, according to an embodiment of the present disclosure, the deep learning model 153 may be trained by using the blurred wafer maps. According to the above description, as well as the case where a wafer map is a binary image, even in the case where a wafer map is a gray image, the deep learning model 153 may be appropriately trained to estimate similar wafer maps with higher performance.

Both the wafer map adjusting operation and the blurring operation of the preprocessing module 151 may be performed in training data construction and similarity estimation to be described later.

Referring to FIG. 3, the storage device 150 may include the training data construction module 152. The training data construction module 152 may construct the training data for learning of the deep learning model 153.

According to an embodiment, the training data construction module 152 may construct the first training data for pre-training the deep learning model 153.

For example, the training data construction module 152 may construct the first training data based on the plurality of first wafer maps including the first target wafer map. In this case, the plurality of first wafer maps and the first target wafer map may be individually selected by the user. Also, the first training data may include the first positive set of wafer maps including wafer maps determined as being similar to the first target wafer map and the first negative set of wafer maps including wafer maps determined as being non-similar to the first target wafer map.

In detail, the training data construction module 152 may randomly extract candidate wafer maps among the plurality of first wafer maps blurred through the preprocessing module 151, and may calculate the similarity of the candidate wafer maps with the blurred first target wafer map, for each of the candidate wafer maps.

In this case, the training data construction module 152 may calculate the similarity based on the pixel-based similarity index. According to an embodiment, Equation 1 below shows the pixel-based similarity index.

$$BIoM ( {X}^{′} , {Y}^{′} ) = \frac{{\sum }_{i} min ( {x}_{i}^{′} , {y}_{i}^{′} )}{max ( {\sum }_{i} {x}_{i}^{′} , {\sum }_{i} {y}_{i}^{′} )} \qquad [ Equation 1 ]$$

$${X}^{′} = f ( X ) , {Y}^{′} = f ( Y ) , {x}_{i}^{′} ∈ {X}^{′} , {y}_{i}^{′} ∈ {Y}^{′}$$

Herein, BIoM (Blurred Intersection over Maximum area) represents the pixel-based similarity index, “X” and “Y” represent different wafer maps, f(⋅) represents a blur filter, and each of

$${x}_{i}^{′} and {y}_{i}^{′}$$

represents an individual pixel constituting each wafer map. According to the pixel-based similarity index, a similarity value between pixels may be calculated on two blurred wafer maps, and a resulting similarity value may have a value between 0 and 1. In this case, as the similarity value becomes closer to 1, the two wafer maps may be determined as similar wafer maps.

The training data construction module 152 may select a first number of similar wafer maps and a second number of non-similar wafer maps from the candidate wafer maps based on the similarities calculated as described above. In this case, the first number of similar wafer maps may be included in the first positive set of wafer maps, and the second number of non-similar wafer maps may be included in the first negative set of wafer maps.

Meanwhile, when the training data construction module 152 constructs the first training data, the training data construction module 152 may use a data augmentation technique. The training data construction module 152 may finely change a shape and/or a location of a defect pattern in a wafer map through the data augmentation technique. For example, the training data construction module 152 may be configured to make fine adjustments to the shape and/or the location of the defect pattern in a wafer map through the data augmentation technique. In this case, the data augmentation technique may include at least one of random rotation, random affine transformation, and local pixel shuffle, but the present disclosure is not limited thereto.

For example, the training data construction module 152 may generate at least one first augmentation wafer map from the blurred first target wafer map by using the data augmentation technique. Also, by using the data augmentation technique, the training data construction module 152 may generate at least one second augmentation wafer map from each of the first number of similar wafer maps and may generate at least one third augmentation wafer map from each of the second number of non-similar wafer maps. In this case, the at least one first augmentation wafer map and the at least one second augmentation wafer map may be included in the first positive set, and the at least one third augmentation wafer map may be included in the first negative set.

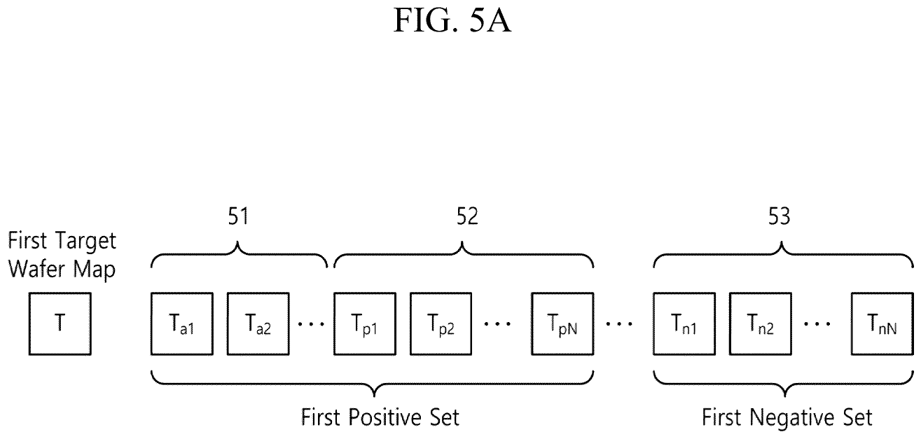

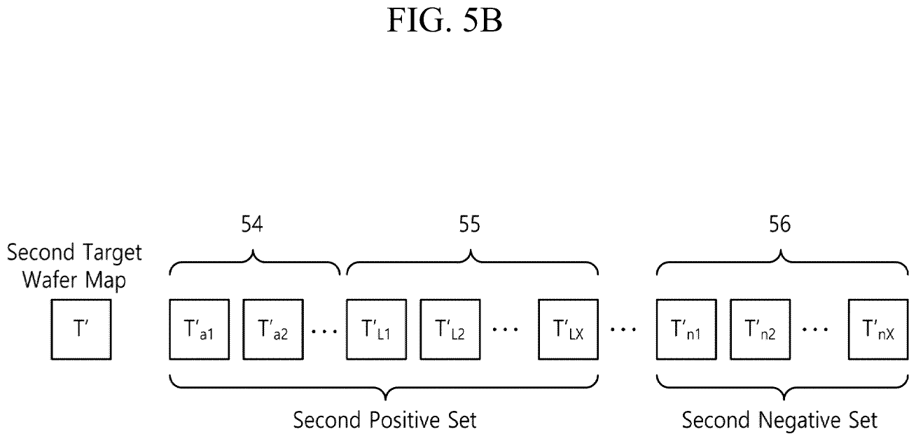

FIG. 5A is a diagram illustrating an example of first training data according to an example embodiment of the present disclosure. Referring to FIG. 5A, the first training data may include the first positive set and the first negative set. According to an embodiment, a first target wafer map “T” may also be seen as being included in the first training data.

In this case, the first positive set may include N similar wafer maps Tₚ₁ to T_{pN} (collectively referred to as “52”) determined as being similar to the first target wafer map depending on the pixel-based similarity index. Also, the first negative set may include N non-similar wafer maps Tₙ₁ to T_{nN} (collectively referred to as “53”) determined as being non-similar to the first target wafer map depending on the pixel-based similarity index. All of the first target wafer map “T”, the N similar wafer maps Tₚ₁ to T_{pN} (52), and the N non-similar wafer maps Tₙ₁ to T_{nN} (53) may be wafer maps blurred by the preprocessing module 151.

Meanwhile, according to an embodiment, the first positive set may further include first augmentation wafer maps Tₐ₁, Tₐ₂, etc. (collectively referred to as “51”) generated from the first target wafer map “T”. Also, although not illustrated in the drawings, second augmentation wafer maps generated from the N similar wafer maps Tₚ₁ to T_{pN} (52) may be included in the first positive set, and third augmentation wafer maps generated from the N non-similar wafer maps Tₙ₁ to T_{nN} (53) may be included in the first negative set.

Meanwhile, according to an embodiment, the training data construction module 152 of FIG. 3 may construct the second training data for post-training the pre-trained deep learning model 153. The second training data may include labeling data. The labeling data may include wafer maps, which are labeled as a wafer map similar to a second target wafer map, from among the plurality of second wafer maps. In this case, the plurality of second wafer maps may be selected by the user. According to an embodiment, the plurality of second wafer maps may be the same as the plurality of first wafer maps described above, or at least some of the plurality of second wafer maps and the plurality of first wafer maps may be different. Meanwhile, the second target wafer map may be a wafer map selected from the plurality of second wafer maps by the user having the domain knowledge associated with similar map determination.

To this end, the training data construction module 152 may construct the labeling data. In this case, the training data construction module 152 may construct the labeling data by using the deep learning model 153 pre-trained based on the first training data and the pixel-based similarity index.

For example, the training data construction module 152 may select a third number of wafer maps from the plurality of second wafer maps in order where the similarity with the second target wafer map estimated by using the pre-trained deep learning model 153 is high. For example, a similarity value between each of the plurality of second wafer maps and the second target wafer map may be estimated using the pre-trained deep learning model 153. A similarity value may have a value between 0 and 1. It may be determined that the closer the similarity value is to 1, the higher the similarity. Also, the training data construction module 152 may select a fourth number of wafer maps from the plurality of second wafer maps in order where the similarity with the second target wafer map calculated depending on the pixel-based similarity index (e.g., the above BIoM) is high. Herein, when the similarity is estimated by using the pre-trained deep learning model 153 or the similarity is calculated based on the pixel-based similarity index, the blurring processing on the plurality of second wafer maps is performed first.

According to the above description, the training data construction module 152 may construct a labeling data candidate group by removing duplicate wafer maps from the third number of wafer maps and the fourth number of wafer maps. Also, the training data construction module 152 may construct the labeling data by labeling a predetermined number of wafer maps among wafer maps included in the labeling data candidate group as a wafer map similar to the second target wafer map. In this case, the predetermined number of wafer maps may be some wafer maps, which are selected by the user having the domain knowledge associated with similar map determination, from among the wafer maps of the labeling data candidate group. For example, the predetermined number of wafer maps may be a subset of wafer maps of the labeling data candidate group, where the subset of wafer maps are selected by the user having the domain knowledge associated with similar map determination.

Meanwhile, the training data construction module 152 may blur the plurality of second wafer maps. In this case, because the plurality of second wafer maps include the second target wafer map and the labeling data, the second target wafer map and the labeled wafer maps are also blurred together with the remaining wafer maps. Also, the training data construction module 152 may construct the second training data from the plurality of second wafer maps that are blurred. In this case, the second training data may include a second positive set including the labeled wafer maps among the plurality of second wafer maps that are blurred. Also, the second training data may include a second negative set including wafer maps, which are relatively low in similarity with the second target wafer map, from among the plurality of second wafer maps that are blurred. In this case, depending on embodiments, the similarity with the second target wafer map may be calculated by using the pixel-based similarity index or may be estimated by using the pre-trained deep learning model 153.

Meanwhile, when the training data construction module 152 constructs the second training data, the training data construction module 152 may use the above data augmentation technique. For example, the training data construction module 152 may generate at least one fourth augmentation wafer map from the blurred first target wafer map and/or each of the blurred labeled wafer maps by using the augmentation technique. In this case, the first positive set may include the blurred labeled wafer maps and the fourth augmentation wafer map.

FIG. 5B is a diagram illustrating an example of second training data according to an example embodiment of the present disclosure. Referring to FIG. 5B, the second training data may include the second positive set of wafer maps and the second negative set of wafer maps. According to an embodiment, a second target wafer map T′ may be seen as being included in the second training data.

In this case, the second positive set may include X labeled wafer maps T′_{L1} to T′_{LX} (collectively referred to as “55”) included in the labeling data. Also, the second negative set may include X wafer maps T′ₙ₁ to T′_{nX} (collectively referred to as “56”) determined as being relatively low in similarity with the second target wafer map based on the pixel-based similarity index or the pre-trained deep learning model 153. All of the second target wafer map T′, the X labeled wafer maps T_{L1} to T_{LX} (55), and the X wafer maps T′ₙ₁ to T′n_{X} (56) may be wafer maps blurred by the preprocessing module 151.

Meanwhile, depending on embodiments, the first positive set may include fourth augmentation wafer maps T′ₐ₁, T′ₐ₂, etc. (collectively referred to as “54”) generated from the second target wafer map T′ or each of the X labeled wafer maps T_{L1} to T_{LX} (55). Also, although not illustrated in drawings, depending on embodiments, augmentation wafer maps generated from the X wafer maps T′ₙ₁ to T′_{nX} (56) may be included in the second negative set.

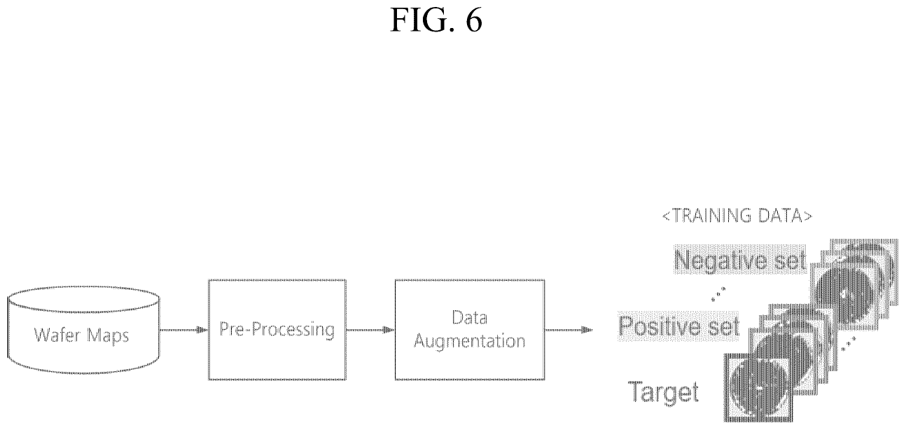

FIG. 6 is a diagram for describing a training data construction operation of a computing device according to an example embodiment of the present disclosure. In FIG. 6, the description duplicative of that given above will be omitted or simplified.

Referring to FIG. 6, the computing device 100 may preprocess wafer maps to construct training data. For example, the computing device 100 may adjust sizes of the wafer maps to the same size in the preprocessing process and may apply the blur filter to the wafer maps. This operation is identically applied to the case of constructing the first training data or the case of constructing the second training data.

Meanwhile, in the case of constructing the first training data, the computing device 100 may calculate similarities of the blurred target wafer map and the remaining blurred wafer maps by using the pixel-based similarity index and may construct the first positive set and the second positive set based on the calculated similarities. In this case, depending on embodiments, the computing device 100 may construct the first training data more abundantly by using the data augmentation technique.

Meanwhile, in the case of constructing the second training data, the wafer maps include the labeling data. In this case, the computing device 100 may construct the second positive set by using the blurred labeling data and may construct the second negative set by applying the pre-trained model or the pixel-based similarity index to the blurred wafer maps. In this case, also, the computing device 100 may construct the second training data more abundantly by using the data augmentation technique.

As illustrated, the training data may include a target wafer map, a positive set of wafer maps, and a negative set of wafer maps, and the computing device 100 may pre-train or post-train the deep learning model 153 by using the constructed training data.

Returning to FIG. 3, the storage device 150 may include the deep learning model 153. The deep learning model 153 may be a model which extracts features or feature vectors based on the convolutional operation. According to an embodiment, the deep learning model 153 may be trained to output an arbitrary feature or feature vector suitable for estimating similarity between wafer maps. Here, the feature may not be defined as any morphological feature such as a width, a circumference, an edge, a distance to the center, and the like, and may be a certain vector created by training the deep learning model 153 to be suitable for estimating similarity between wafer maps. In this case, the distances between features extracted from similar wafer maps may be close to each other, and the distances of features extracted from similar wafer maps may be far from each other. For example, the deep learning model may be a CNN model such as a visual geometry group (VGG), residual networks (ResNet), a dense convolutional network (DenseNet), or an EfficientNet, but the present disclosure is not limited thereto.

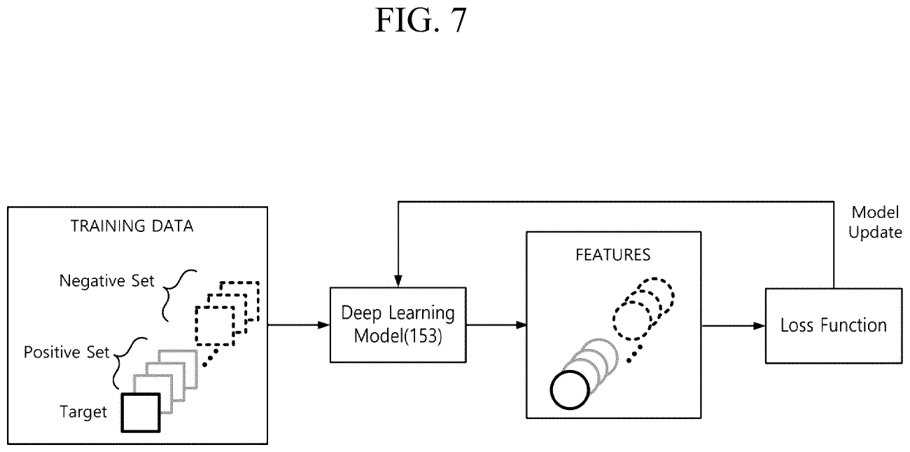

The storage device 150 may include the training module 154. The training module 154 may train the deep learning model 153. FIG. 7 is a diagram illustrating an example of a process of training a deep learning model according to an example embodiment of the present disclosure. Referring to FIG. 7, the training module 154 may input the training data to the deep learning model 153 and may extract features for each of wafer maps included in the training data. Also, the training module 154 may calculate a loss function based on the extracted features and may update parameters (or weights) of the deep learning model 153 through a backpropagation algorithm such that an error calculated through the loss function decreases.

In this case, according to an embodiment, a Smooth-AP may be used as the loss function. The Smooth-AP may be implemented by transforming an average precision (AP) being an indicator for evaluating the performance of a model during object detection so as to be used as the loss function in the process of training the deep learning model. In a conventional self-supervised learning method, a contrastive loss is mainly used as the loss function. Compared to the contrastive loss, the Smooth-AP may apply a greater penalty when a wafer map being low in similarity with the target wafer map is misjudged as being high in similarity with the wafer map, and thus, the Smooth-AP may react sensitively.

According to an embodiment, the training module 154 may pre-train the deep learning model 153 based on the first training data. For example, the training module 154 may input the blurred first target wafer map and the first training data to the deep learning model 153 to extract features. According to the above description, the training module 154 may update the parameters of the deep learning model 153 by applying the loss function to the extracted features.

Also, according to an embodiment, the training module 154 may post-train the deep learning model 153 based on the second training data. The post-training may refer to an operation of finely tuning the pre-trained deep learning model 153. To this end, the training module 154 may initialize the deep learning model 153 with parameters of a previously pre-trained deep learning model. According to the above description, the training module 154 may input the blurred second target wafer map and the second training data to the deep learning model 153 to extract features and may update the parameters of the deep learning model 153 by applying the loss function to the extracted features. Accordingly, the parameters of the pre-trained deep learning model 153 may be finely tuned.

Returning to FIG. 3, the storage device 150 may include the similarity estimation model 155. The similarity estimation model 155 may output similarity rankings of the plurality of wafer maps, which is associated with the target wafer map, by using the deep learning model 153. For example, the similarity estimation model 155 may calculate the similarity with the target wafer map for each comparison-targeted wafer map by using the deep learning model 153. The similarity estimation model 155 may output the similarity ranking of each comparison-targeted wafer map based on the calculated similarity.

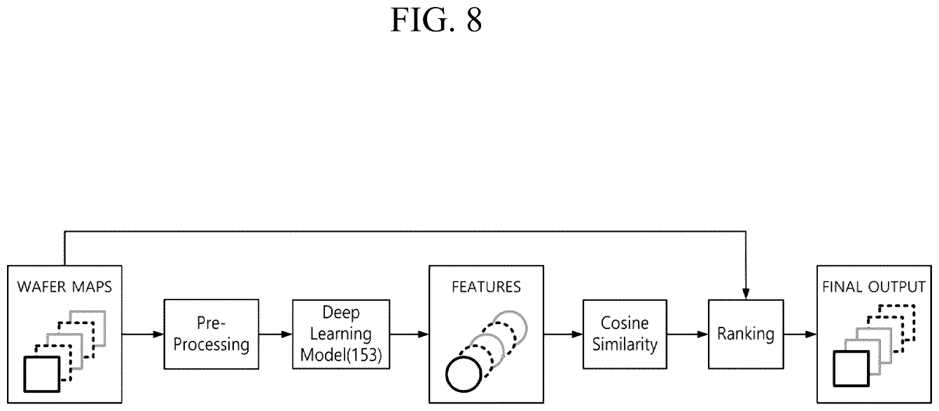

FIG. 8 is a diagram illustrating an example of a similarity estimation process of a deep learning model according to an example embodiment of the present disclosure. Referring to FIG. 8, the similarity estimation model 155 may preprocess the plurality of wafer maps including the target wafer map by using the preprocessing module 151. In this case, all the preprocessed wafer maps may have the same size and may be blurred.

The similarity estimation model 155 may input the preprocessed wafer maps to the deep learning model 153 to extract features of each wafer map. Also, the similarity estimation model 155 may calculate a cosine similarity function based on the extracted features and may estimate the similarity with the target wafer map for each of the plurality of wafer maps. According to the above description, the similarity estimation model 155 may align the plurality of wafer maps in order of similarity ranking based on the estimated similarities and may output the plurality of wafer maps thus aligned.

According to an embodiment, the similarity estimation model 155 may output the similarity ranking based on the pre-trained deep learning model 153. As an example embodiment, the similarity estimation model 155 may blur the plurality of second wafer maps including the second target wafer map and may input the plurality of second wafer maps thus blurred to the pre-trained deep learning model 153 to extract the features of each wafer map. According to the above description, the similarity estimation model 155 may estimate the similarity with the second target wafer map for each of the plurality of second wafer maps, based on the extracted features. Also, the similarity estimation model 155 may align the plurality of second wafer maps in order of similarity ranking based on the estimated similarities, and may output the plurality of second wafer maps that are aligned by the similarity estimation model 155.

Also, according to an embodiment, the similarity estimation model 155 may output the similarity rankings based on the post-trained deep learning model 153. As an example embodiment, the similarity estimation model 155 may blur the plurality of wafer maps including the target wafer map selected by the user, and may input the plurality of wafer maps thus blurred to the post-trained deep learning model 153 to extract the features of each wafer map. For example, the similarity estimation model 155 may output the plurality of blurred wafer maps, including the target wafer map selected by the user, to the post-trained deep learning model 153, and the post-trained deep learning model 153 may extract the features of each wafer map of the plurality of blurred wafer maps. According to the above description, the similarity estimation model 155 may estimate the similarity with the target wafer map for each of the plurality of wafer maps, based on the extracted features. Also, the similarity estimation model 155 may align the plurality of wafer maps in order of similarity ranking based on the estimated similarities and may output the plurality of wafer maps thus aligned. For example, for each of the plurality of blurred wafer maps, the similarity estimation model 155 may estimate the similarity with the target wafer map based on the extracted features, align the plurality of blurred wafer maps in order of similarity ranking based on the estimated similarities, and output the plurality of blurred wafer maps in the order of their alignment.

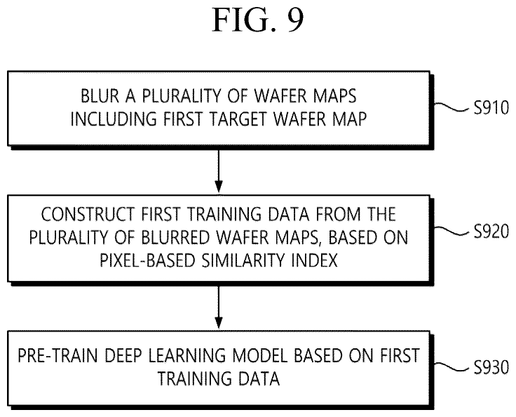

FIG. 9 is a flowchart illustrating a deep learning model training process of a computing device according to an example embodiment of the present disclosure. Referring to FIG. 9, in operation S910, the computing device 100 may blur the plurality of wafer maps including the first target wafer map. In this case, the computing device 100 may blur the plurality of wafer maps by using the blur filter. The blur filter may be a Gaussian filter or an average filter, but the present disclosure is not limited thereto.

In operation S920, the computing device 100 may construct the first training data from the plurality of wafer maps thus blurred, based on the pixel-based similarity index.

According to an embodiment, the computing device 100 may calculate the similarity with the first target wafer map for each of the plurality of wafer maps, based on the pixel-based similarity index expressed by Equation 1 above.

The computing device 100 may construct the first training data including the first positive set of wafer maps and the first negative set of wafer maps based on the similarity calculated as described above. In this case, the first positive set may include wafer maps, which are relatively high in similarity with the first target wafer map, from among the plurality of wafer maps thus blurred. Also, the first negative set may include wafer maps, which are relatively low in similarity according to the similarity index, from among the plurality of wafer maps thus blurred.

In operation S930, the computing device 100 may pre-train the deep learning model 153 based on the first training data. In this case, the deep learning model 153 may be a model which extracts features based on the convolutional operation. According to an embodiment, the deep learning model 153 may be a convolutional neural network (CNN), but the present disclosure is not limited thereto.

In detail, the computing device 100 may input the blurred first target wafer map and the first training data to the deep learning model 153 to extract features and may update the parameters of the deep learning model 153 by applying the loss function to the extracted features. In this case, the loss function may be a Smooth-AP, but the present disclosure is not limited thereto.

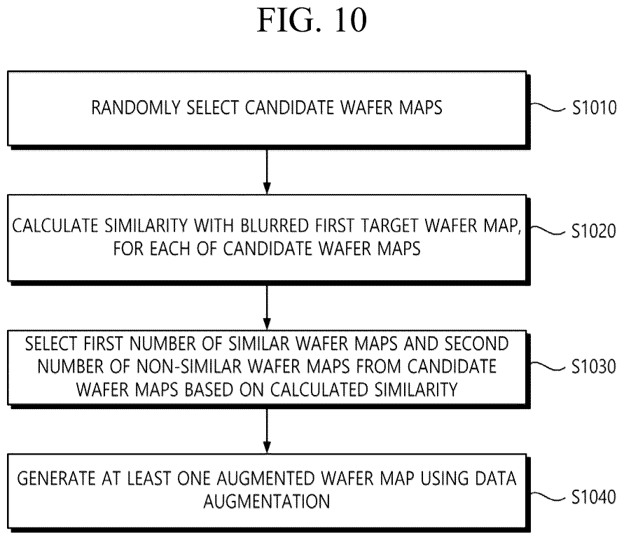

FIG. 10 is a flowchart illustrating a training data construction process of a computing device according to an example embodiment of the present disclosure. In detail, FIG. 10 shows the process of constructing the first training data described above.

Referring to FIG. 10, in operation S1010, the computing device 100 may randomly select the candidate wafer maps among the plurality of wafer maps thus blurred. Also, in operation S1020, the computing device 100 may calculate the similarity with the blurred first target wafer map for each of the candidate wafer maps by using the pixel-based similarity index. As discussed above, a similarity value between pixels may be calculated between the blurred first target wafer map and each of the candidate wafer maps, and a resulting similarity value for the two wafer maps may be between 0 and 1. As also discussed above, as the similarity value becomes closer to 1, the two wafer maps may be determined to be similar wafer maps.

In operation S1030, the computing device 100 may select a first number of similar wafer maps and a second number of non-similar wafer maps from the candidate wafer maps based on the calculated similarities. For example, the computing device 100 may select the first number of similar wafer maps in order where the calculated similarity is high. Also, the computing device 100 may select the second number of non-similar wafer maps in order where the calculated similarity is low. However, an embodiment is not limited thereto. In this case, the first number of similar wafer maps may be included in the first positive set, and the second number of non-similar wafer maps may be included in the first negative set.

In operation S1040, the computing device 100 may generate at least one augmentation wafer map by using the data augmentation technique and may include the generated augmentation wafer map(s) in the first training data. In detail, the computing device 100 may generate at least one first augmentation wafer map from the blurred first target wafer map by using the data augmentation technique. Also, the computing device 100 may generate at least one second augmentation wafer map from each of the first number of similar wafer maps by using the data augmentation technique. In this case, the first augmentation wafer maps and the second augmentation wafer maps may be included in the first positive set.

Meanwhile, the computing device 100 may generate at least one third augmentation wafer map from each of the second number of non-similar wafer maps by using the data augmentation technique. In this case, the third augmentation wafer maps may be included in the first negative set.

According to the above description, the first training data including the first positive set and the first negative set may be constructed.

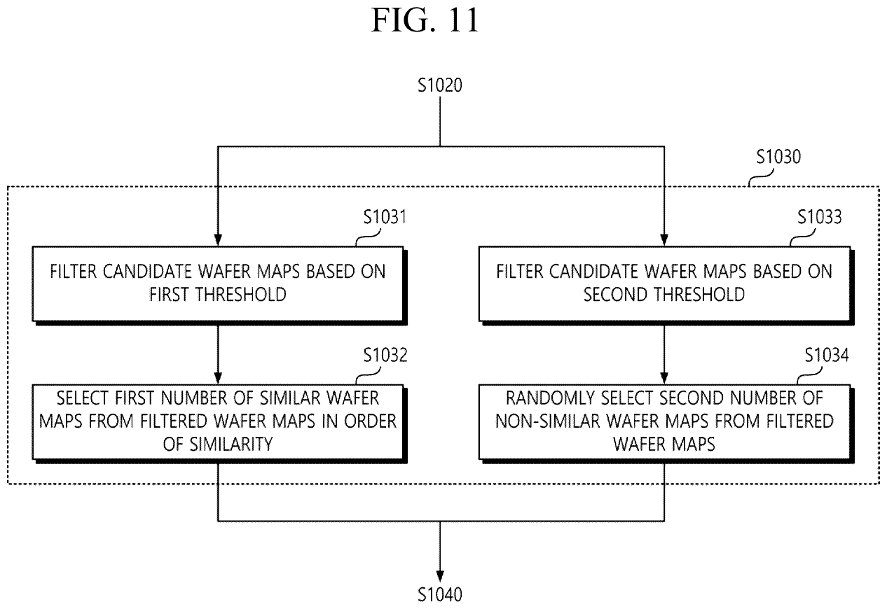

FIG. 11 is a flowchart illustrating a training data construction process of a computing device according to an example embodiment of the present disclosure. In detail, operations of FIG. 11 may be an implementation example of operation S1030 of FIG. 10.

Referring to FIG. 11, in operation S1031, the computing device 100 may filter the candidate wafer maps based on a first threshold value. In detail, the computing device 100 may select wafer maps, which have similarities greater than the first threshold value, from among the candidate wafer maps.

The first threshold value may be a value between 0 and 1. For example, the first threshold value may be 0.9. Thus, in this example, the computing device 100 may select wafer maps from the candidate wafer maps that have a pixel-based similarity index that is equal to or greater than 0.9. When the output of the pixel-based similarity index is equal to or greater than 0.9, then the two wafer maps may be considered to be relatively high in similarity.

In operation S1032, the computing device 100 may select the first number of similar wafer maps from the filtered wafer maps in order of similarity. In detail, the computing device 100 may select the first number of similar wafer maps from wafer maps each having a similarity greater than the first threshold value, in order of high similarity.

In operation S1033, the computing device 100 may filter the candidate wafer maps based on a second threshold value. In detail, the computing device 100 may select wafer maps, which have similarities smaller than the second threshold value, from among the candidate wafer maps.

The second threshold value may be a value between 0 and 1. For example, the second threshold value may be 0.5. Thus, in this example, the computing device 100 may select wafer maps from the candidate wafer maps that have a pixel-based similarity index that is less than 0.5. When the output of the pixel-based similarity index is less than 0.5, then the two wafer maps may be considered to be relatively low in similarity.

In operation S1034, the computing device 100 may randomly select the second number of non-similar wafer maps from the filtered wafer maps. In detail, the computing device 100 may randomly select the second number of non-similar wafer maps from wafer maps each having a similarity smaller than the second threshold value. However, an embodiment is not limited thereto. For example, in operation S1034, the computing device 100 may select the second number of non-similar wafer maps in order of low similarity.

Wafer maps having a similarly value equal to or greater than the second threshold value and less than the first threshold value may not be used by the computing device 100 to develop the pre-trained deep learning model.

Meanwhile, in FIGS. 10 and 11, the case where the computing device 100 selects one candidate group from the plurality of wafer maps thus blurred and similar wafer maps and non-similar wafer maps are selected from the selected candidate group is provided as an example, but an embodiment is not limited thereto. For example, the computing device 100 may independently select a candidate group for selecting similar wafer maps and a candidate group for selecting non-similar wafer maps.

In detail, the computing device 100 may randomly select first candidate wafer maps from the plurality of wafer maps thus blurred and may select the first number of similar wafer maps from the first candidate wafer maps. In this case, according to an embodiment, the computing device 100 may select wafer maps, which have similarities greater than the first threshold value, from among the first candidate wafer maps and may select the first number of similar wafer maps from the selected wafer maps in order of high similarity. Meanwhile, the computing device 100 may randomly select second candidate wafer maps from the plurality of wafer maps thus blurred and may select the second number of non-similar wafer maps from the first candidate wafer maps. In this case, according to an embodiment, the computing device 100 may select wafer maps, which have similarities smaller than the second threshold value, from among the second candidate wafer maps and may randomly select the second number of non-similar wafer maps from the selected wafer maps.

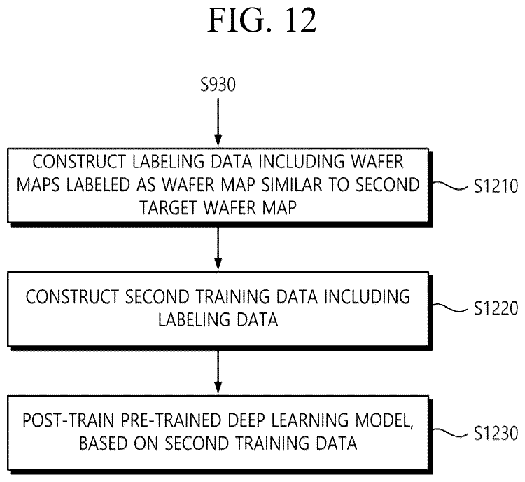

FIG. 12 is a flowchart illustrating a deep learning model training process of a computing device according to an example embodiment of the present disclosure. In detail, FIG. 12 shows a process of post-training the deep learning model 153 according to an embodiment of the present disclosure.

Referring to FIG. 12, after the pre-training of the deep learning model 153 is completely performed in operation S930 of FIG. 9, in operation S1210, the computing device 100 may construct the labeling data including wafer maps labeled as a wafer map similar to the second target wafer map. In this case, the second target wafer map may be a wafer map selected by the user having the domain knowledge as representing the plurality of wafer maps.

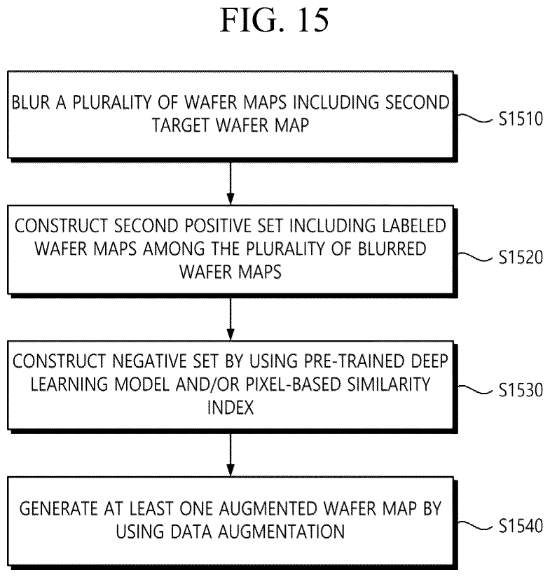

In operation S1220, the computing device 100 may construct the second training data including the labeling data. This will be described in detail with reference to FIG. 15.

In operation S1230, the computing device 100 may post-train the pre-trained deep learning model 153 based on the second training data. For example, the computing device 100 may initialize the deep learning model 153. In this case, the initialization may be a process of applying the parameters of the deep learning model 153 to the deep learning model 153. Also, the computing device 100 may input the blurred second target wafer map and the second training data to the initialized deep learning model 153 to extract features. According to the above description, the computing device 100 may post-train the deep learning model 153 by updating the parameters of the deep learning model 153 by applying the loss function (e.g., the Smooth-AP) to the extracted features.

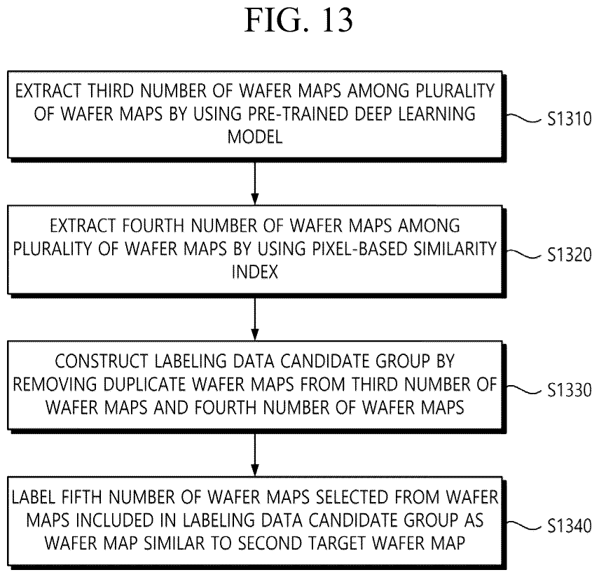

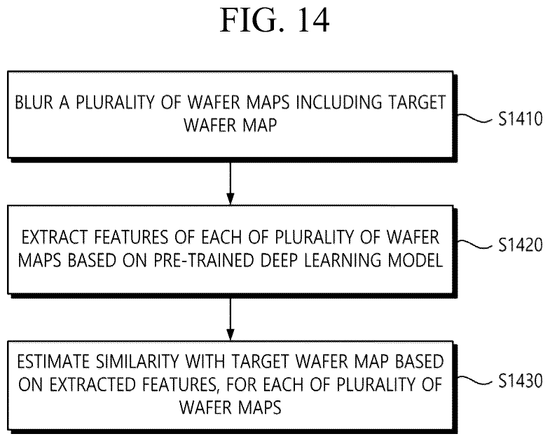

FIG. 13 is a flowchart illustrating a labeling data construction process of a computing device according to an example embodiment of the present disclosure. Referring to FIG. 13, in operation S1310, the computing device 100 may extract the third number of wafer maps among the plurality of wafer maps by using the pre-trained deep learning model. For example, the computing device 100 may select the third number of wafer maps from the plurality of wafer maps in order where the similarity with the second target wafer map estimated by using the pre-trained deep learning model 153 is high. This will be described in detail with reference to FIG. 14.

In operation S1320, the computing device 100 may extract the fourth number of wafer maps among the plurality of wafer maps by using the pixel-based similarity index. For example, the computing device 100 may select the fourth number of wafer maps from the plurality of wafer maps in order where the similarity with the second target wafer map calculated depending on the pixel-based similarity index (e.g., the above BIoM) is high. In detail, the computing device 100 may blur the plurality of wafer maps including the second target wafer map. Also, the computing device 100 may calculate the similarity with the blurred second target wafer map for each of the plurality of wafer maps thus blurred. In this case, the computing device 100 may calculate the similarity by using the pixel-based similarity index described above. According to the above description, the computing device 100 may select the fourth number of wafer maps in order where the calculated similarity is high.

In operation S1330, the computing device 100 may construct the labeling data candidate group by removing duplicate wafer maps from the third number of wafer maps and the fourth number of wafer maps. For example, the labeling data candidate group may include the third and fourth number of wafer maps from which duplicate wafer maps have been removed. In detail, because the third number of wafer maps and the fourth number of wafer maps are independently selected by using the pre-trained deep learning model 153 and the pixel-based similarity index, one or more of the same wafer maps may be included in both the third number of wafer maps and the fourth number of wafer maps. In this case, the computing device 100 may construct the labeling data candidate group in which there is no duplicate wafer map, by removing the duplicate wafer maps from either the third number of wafer maps or the fourth number of wafer maps.

In operation S1340, the computing device 100 may label a fifth number of wafer maps selected from wafer maps included in the labeling data candidate group as a wafer map similar to the second target wafer map. In this case, the fifth number of wafer maps may be some wafer maps, which are selected by the user having the domain knowledge associated with similar map determination, from among the wafer maps of the labeling data candidate group.

FIG. 14 is a flowchart illustrating a similarity estimation process of a computing device according to an example embodiment of the present disclosure. Referring to FIG. 14, in operation S1410, the computing device 100 may blur the plurality of wafer maps including the target wafer map.

In operation S1420, the computing device 100 may extract features of each of the plurality of wafer maps based on the pre-trained deep learning model 153. For example, the computing device 100 may input the plurality of wafer maps thus blurred to the pre-trained deep learning model 153 and may extract the features of each wafer map.

In operation S1430, the communication device 140 may estimate the similarity with the target wafer map for each of the plurality of wafer maps, based on the extracted features.

The above operation of estimating the similarity by using the pre-trained deep learning model 153 may be used for implementation of operation S1310 described above. In detail, the computing device 100 may blur the plurality of wafer maps including the second target wafer map and may input the plurality of wafer maps thus blurred to the pre-trained deep learning model 153 to extract the features of each of the plurality of wafer maps. Also, the computing device 100 may estimate the similarity with the second target wafer map for each of the plurality of wafer maps by calculating the cosine similarity function based on the extracted features. The cosine similarity function may output a value between 0 and 1, and the similarity between two wafer maps may be considered high as a similarity value becomes closer to 1. According to the above description, the computing device 100 may select the third number of wafer maps from the plurality of wafer maps in order where the similarity with the estimated second target wafer map is high.

FIG. 15 is a flowchart illustrating a training data construction process of a computing device according to an embodiment of the present disclosure. In detail, FIG. 15 shows a second training data construction operation of the computing device 100.

Referring to FIG. 15, in operation S1510, the computing device 100 may blur the plurality of wafer maps. In this case, the plurality of wafer maps may include the second target wafer map. Also, the plurality of wafer maps may include the labeling data constructed as described with reference to FIG. 13.

Accordingly, in operation S1520, the computing device 100 may construct the second positive set including labeled wafer maps among the plurality of wafer maps thus blurred.

Meanwhile, in operation S1530, the computing device 100 may construct the second negative set by using the pre-trained deep learning model 153 or the pixel-based similarity index. For example, the computing device 100 may estimate the similarity with the second target wafer map for each of the plurality of wafer maps by using the pre-trained deep learning model 153 and may construct the second negative set including wafer maps which are relatively low in estimated similarity. Alternatively, the computing device 100 may calculate the similarity with the second target wafer map for each of the plurality of wafer maps by using the pixel-based similarity index and may construct the second negative set including wafer maps which are relatively low in calculated similarity.

The case where the computing device 100 separately uses the pre-trained deep learning model 153 or the pixel-based similarity index to construct the second negative set is described above as an example, but the present disclosure is not limited thereto. According to an embodiment, the computing device 100 may construct the second negative set by using the similarity estimated or calculated in the process of constructing the labeling data candidate group. In detail, for example, the computing device 100 may construct the second negative set by using the similarity estimated in operation S1310 or may construct the second negative set by using the similarity calculated in operation S1320.

Meanwhile, in operation S1540, the computing device 100 may generate at least one augmentation wafer map by using the data augmentation technique. For example, the computing device 100 may generate at least one fourth augmentation wafer map from each of the blurred second wafer map and the blurred labeled wafer maps, by using the data augmentation technique and may construct the second positive set further including the generated fourth augmentation wafer map.

The computing device 100 may construct the second training data set including the second positive set and the second negative set constructed as described above.

According to various embodiments of the present disclosure described above, a deep learning model training method capable of more accurately estimating similar wafer maps being similar in defect pattern to a target wafer map and a computing device performing the same may be provided.

Meanwhile, various embodiments of the present disclosure may be implemented by software including instructions stored in a machine (e.g., computer)-readable storage medium. Herein, the machine which is a device capable of calling the stored instruction from the storage medium and operating based on the called instruction and may include the computing device 100 according to the disclosed embodiments.

When the command is executed by various kinds of processors, the processor may perform a function corresponding to the instruction directly or using any other components under control of the processor. The instruction may include a code which is generated or executed by a compiler or interpreter. The machine-readable storage medium may be provided in the form of a non-transitory storage medium. Herein, the term “non-transitory” merely means that the storage medium does not include a signal and is tangible; it does not distinguish whether data are stored semi-permanently or temporarily on the storage medium.

According to an embodiment, the deep learning model training method according to various embodiments of the present disclosure may be provided as part of a computer program product. The computer program product may be traded between a seller and a buyer as a commodity. The computer program product may be distributed online in the form of a machine-readable storage medium (e.g., a compact disk read only memory (CD-ROM)) or through an application store (e.g., Play Store™). In the case of the online distribution, at least part of the computer program product may be at least temporarily stored in a storage medium, such as a server of a manufacturer, a server of an application store, or a memory of a relay server) or may be temporarily generated.

As is traditional in the field of the disclosed technology, features and embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

Each component (e.g., a module or a program) according to various embodiments may include a single entity or a plurality of entities; some of the above corresponding sub components may be omitted, or any other sub component may be further included in various embodiments. Alternatively or additionally, some components (e.g., modules or programs) may be integrated into one entity such that a function of each component is performed to be identical or similar to that before the integration. According to various embodiments, operations which are executed by modules, program modules, or other components may be executed by a successive method, a parallel method, a repeated method, or a heuristic method. Alternatively, at least some of the operations may be executed in another order or may be omitted, or any other operation may be added thereto.

According to various embodiments of the present disclosure described above, a deep learning model training method capable of more accurately estimating similar wafer maps being similar in defect pattern to a target wafer map and a computing device performing the same may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of training a deep learning model for wafer map similarity estimation, wherein the method is performed by a computing device including at least one processor, the method comprising:
blurring a plurality of wafer maps including a first target wafer map to provide a plurality of blurred wafer maps including a blurred first target wafer map;
constructing first training data from the plurality of blurred wafer maps, based on a pixel-based similarity index; and
pre-training the deep learning model based on the first training data,
wherein the first training data includes a first positive set of wafer maps and a first negative set of wafer maps,
wherein the first positive set of wafer maps includes wafer maps, which are high in similarity with the blurred first target wafer map according to the pixel-based similarity index, from among the plurality of blurred wafer maps, and
wherein the first negative set of wafer maps includes wafer maps, which are low in similarity with the blurred first target wafer map according to the pixel-based similarity index, from among the plurality of blurred wafer maps.

2. The method of claim 1, wherein the constructing of the first training data includes:
randomly selecting candidate wafer maps from the plurality of blurred wafer maps;
calculating a similarity with the blurred first target wafer map by using the pixel-based similarity index, for each of the candidate wafer maps; and
selecting a first number of similar wafer maps and a second number of non-similar wafer maps from the candidate wafer maps based on the calculated similarity for each of the candidate wafer maps,
wherein the first positive set of wafer maps includes the first number of similar wafer maps, and
wherein the first negative set of wafer maps includes the second number of non-similar wafer maps.

3. The method of claim 2, wherein the constructing of the first training data further includes:
generating at least one first augmentation wafer map from the blurred first target wafer map by using a data augmentation technique;
generating at least one second augmentation wafer map from each of the first number of similar wafer maps by using the data augmentation technique; and
generating at least one third augmentation wafer map from each of the second number of non-similar wafer maps by using the data augmentation technique,
wherein the first positive set of wafer maps includes the at least one first augmentation wafer map and the at least one second augmentation wafer map, and
wherein the first negative set of wafer maps includes the at least one third augmentation wafer map.

4. The method of claim 2, wherein the selecting of the first number of similar wafer maps and the second number of non-similar wafer maps includes:
selecting wafer maps, each of which has the calculated similarity greater than a first threshold value, from among the candidate wafer maps; and
selecting the first number of similar wafer maps from the wafer maps, each of which has the calculated similarity greater than the first threshold value, in order of the calculated similarity.

5. The method of claim 2, wherein the selecting of the first number of similar wafer maps and the second number of non-similar wafer maps includes:
selecting wafer maps, each of which has the calculated similarity smaller than a second threshold value, from among the candidate wafer maps; and
randomly selecting the second number of non-similar wafer maps from the wafer maps, each of the second number of non-similar wafer having the calculated similarity smaller than the second threshold value.

6. The method of claim 1, wherein the pixel-based similarity index is calculated based on the following Equation:
$$BIoM ( {X}^{′} , {Y}^{′} ) = \frac{{\sum }_{i} min ( {x}_{i}^{′} , {y}_{i}^{′} )}{max ( {\sum }_{i} {x}_{i}^{′} , {\sum }_{i} {y}_{i}^{′} )}$$
$${X}^{′} = f ( X ) , {Y}^{′} = f ( Y ) , {x}_{i}^{′} ∈ {X}^{′} , {y}_{i}^{′} ∈ {Y}^{′}$$
in which BIoM represents the pixel-based similarity index, “X” and “Y” represent different wafer maps, f(⋅) represents a blur filter, and each of
$${x}_{i}^{′} and {y}_{i}^{′}$$
represents an individual pixel of each wafer map.

7. The method of claim 1,
wherein the deep learning model is a model extracting features based on a convolutional operation, and
wherein the pre-training includes:
inputting the blurred first target wafer map and the first training data to the deep learning model to extract features; and
applying a loss function to the extracted features to update parameters of the deep learning model.

8. The method of claim 1, further comprising:
constructing labeling data including wafer maps, each of which is labeled as a wafer map similar to a second target wafer map, from among the plurality of wafer maps;
constructing second training data including the labeling data; and
post-training the pre-trained deep learning model based on the second training data,
wherein the second target wafer map is a wafer map, which is selected by a user having domain knowledge, from among the plurality of wafer maps.

9. The method of claim 8, wherein the constructing of the labeling data includes:
selecting a third number of wafer maps from the plurality of wafer maps in order where a similarity with the second target wafer map estimated by using the pre-trained deep learning model is high;
selecting a fourth number of wafer maps from the plurality of wafer maps in order where a similarity with the second target wafer map calculated according to the pixel-based similarity index is high;
constructing a labeling data candidate group by removing duplicate wafer maps from the third number of wafer maps and the fourth number of wafer maps; and
labeling a fifth number of wafer maps selected from wafer maps included in the labeling data candidate group as a wafer map similar to the second target wafer map.

10. The method of claim 9, wherein the selecting of the third number of wafer maps includes:
blurring the plurality of wafer maps to provide a second plurality of blurred wafer maps;
inputting the second plurality of blurred wafer maps to the pre-trained deep learning model to extract features of each wafer map;
estimating a similarity with the second target wafer map based on the extracted features, for each of the second plurality of blurred wafer maps; and
selecting the third number of wafer maps based on the estimated similarity for each of the second plurality of blurred wafer maps.

11. The method of claim 8,
wherein the constructing of the second training data includes:
blurring the plurality of wafer maps including the second target wafer map to provide a second plurality of blurred wafer maps including a blurred second target wafer map; and
constructing the second training data from the second plurality of blurred wafer maps, and
wherein the second training data includes:
a second positive set of wafer maps including the labeled wafer maps among the second plurality of blurred wafer maps; and
a second negative set of wafer maps including wafer maps, which are low in a similarity with the blurred second target wafer map according to the pixel-based similarity index, from among the second plurality of blurred wafer maps, or including wafer maps, which are low in a similarity with the blurred second target wafer map estimated by using the pre-trained deep learning model, from among the second plurality of blurred wafer maps.

12. The method of claim 11, further comprising:
generating at least one fourth augmentation wafer map from each of the blurred second target wafer map and the blurred labeled wafer maps by using a data augmentation technique,
wherein the second positive set of wafer maps includes the at least one fourth augmentation wafer map.

13. The method of claim 8, wherein the post-training includes:
applying parameters of the pre-trained deep learning model to the deep learning model;
inputting the second target wafer map and the second training data to the deep learning model to extract features; and
applying a loss function to the extracted features to update parameters of the deep learning model.

14. A computing device comprising:
a processor including at least one core; and
a memory including program codes and a deep learning model, which are executable in the processor,
wherein the processor is configured to:
execute at least some of the program codes to blur a plurality of wafer maps including a first target wafer map to provide a plurality of blurred wafer maps including a blurred first target wafer map;
construct first training data from the plurality of blurred wafer maps, based on pixel-based similarity index; and
pre-train the deep learning model based on the first training data,
wherein the first training data includes a first positive set of wafer maps and a first negative set of wafer maps,
wherein the first positive set of wafer maps includes wafer maps, which are high in a similarity with the blurred first target wafer map according to the pixel-based similarity index, from among the plurality of blurred wafer maps, and
wherein the first negative set of wafer maps includes wafer maps, which are low in the similarity, from among the plurality of blurred wafer maps.

15. The computing device of claim 14, wherein the processor is configured to:
randomly select candidate wafer maps from the plurality of blurred wafer maps;
calculate a similarity with the blurred first target wafer map by using the pixel-based similarity index, for each of the candidate wafer maps; and
select a first number of similar wafer maps and a second number of non-similar wafer maps from the candidate wafer maps based on the calculated similarity for each of the candidate wafer maps,
wherein the first positive set of wafer maps includes the first number of similar wafer maps, and
wherein the first negative set of wafer maps includes the second number of non-similar wafer maps.

16. The computing device of claim 15, wherein the processor is configured to:
generate at least one first augmentation wafer map from the blurred first target wafer map by using a data augmentation technique;
generate at least one second augmentation wafer map from each of the first number of similar wafer maps; and
generate at least one third augmentation wafer map from each of the second number of non-similar wafer maps,
wherein the first positive set includes the at least one first augmentation wafer map and the at least one second augmentation wafer map, and
wherein the first negative set includes the at least one third augmentation wafer map.

17. The computing device of claim 14, wherein the processor is configured to:
calculate a similarity according to the pixel-based similarity index based on the following Equation:
$$BIoM ( {X}^{′} , {Y}^{′} ) = \frac{{\sum }_{i} min ( {x}_{i}^{′} , {y}_{i}^{′} )}{max ( {\sum }_{i} {x}_{i}^{′} , {\sum }_{i} {y}_{i}^{′} )}$$
$${X}^{′} = f ( X ) , {Y}^{′} = f ( Y ) , {x}_{i}^{′} ∈ {X}^{′} , {y}_{i}^{′} ∈ {Y}^{′}$$
in which BIoM represents the pixel-based similarity index, “X” and “Y” represent different wafer maps, f(⋅) represents a blur filter, and each of
$${x}_{i}^{′} and {y}_{i}^{′}$$
represents an individual pixel of each wafer map.

18. The computing device of claim 14, wherein the processor is configured to:
construct labeling data including wafer maps, which are labeled as a wafer map similar to a second target wafer map, from among the plurality of wafer maps;
construct second training data including the labeling data; and
post-train the pre-trained deep learning model based on the second training data, and
wherein the second target wafer map is a wafer map, which is selected by a user having domain knowledge, from among the plurality of wafer maps.

19. The computing device of claim 18, wherein the processor is configured to:
select a third number of wafer maps from the plurality of wafer maps in order where a similarity with the second target wafer map estimated by using the pre-trained deep learning model is high;
select a fourth number of wafer maps from the plurality of wafer maps in order where a similarity with the second target wafer map calculated according to the pixel-based similarity index is high;
construct a labeling data candidate group by removing duplicate wafer maps from the third number of wafer maps and the fourth number of wafer maps; and
label a fifth number of wafer maps selected from wafer maps included in the labeling data candidate group as a wafer map similar to the second target wafer map.

20. A non-transitory computer-readable recording medium storing a program, wherein the programs, when executed by a processor of a computing device, causes the computing device to perform an operation, the operation comprising:
blurring a plurality of wafer maps including a first target wafer map to provide a plurality of blurred wafer maps including a blurred first target wafer map;
constructing first training data from the plurality of blurred wafer maps, based on pixel-based similarity index;
pre-training a deep learning model based on the first training data;
constructing labeling data including wafer maps, which are labeled as a wafer map similar to a second target wafer map, from among the plurality of wafer maps;
constructing second training data including the labeling data; and
post-training the pre-trained deep learning model based on the second training data,
wherein the first training data includes a first positive set of wafer maps and a first negative set of wafer maps,
wherein the first positive set of wafer maps includes wafer maps, which are high in a similarity with the blurred first target wafer map according to the pixel-based similarity index, from among the plurality of blurred wafer maps,
wherein the first negative set of wafer maps includes wafer maps, which are low in the similarity, from among the plurality of blurred wafer maps, and
wherein the second target wafer map is a wafer map, which is selected by a user having domain knowledge, from among the plurality of wafer maps.
